(19) United States
(12) Patent Application Publication
(10) Pub. No.: US 2014/0289565 A1
(43) Pub. Date: Sep. 25, 2014

(54) Process and System for Verifying Computer Program on a Smart Card

(71) Applicant: NXP B.V., EINDHOVEN (NL)

(72) Inventors: Reinhard Berlach, Trattenbach (AT); Johannes Loinig, Lannach (AT); Ernst Haselsteiner, Graz (AT)

(73) Assignee: NXP B.V., EINDHOVEN (NL)

(21) Appl. No.: 14/188,147

(22) Filed: Feb. 24, 2014

(30) Foreign Application Priority Data
Mar. 19, 2013 (EP) 13159893.0

(51) Int. Cl. G06F 11/36

(52) U.S. Cl. CPC G06F 11/3688
USPC 714/38.1

(57) ABSTRACT

According to an aspect of the invention, a process for verifying a computer program on a smart card is conceived, the process comprising: identifying, within said computer program, one or more instruction sequences that have a single start point and one or more end points in the program flow; identifying, in each instruction sequence, one or more basic blocks that have a single start point and a single end point in the program flow; and verifying the instruction sequences by verifying each basic block identified in said instruction sequences.

### FIELD OF THE INVENTION

The invention relates a process for verifying a computer program on a smart card. The invention also relates to a corresponding system for verifying a computer program on a smart card.

### BACKGROUND OF THE INVENTION

It is known that smart cards may execute applications based on interpreted instructions using a virtual machine. For example, Java Cards comprise a Java Virtual Machine that interprets so-called byte codes. Such smart cards are general-purpose smart cards which may be used, in a smart card form factor, for banking or electronic identification cards. In other form factors they may be used as electronic passports or they may serve as a secure element in mobile phones to allow mobile payment. Because of their general-purpose nature they are also often used as anti-counterfeit devices in gaming consoles or accessories for mobile phones or MP3 players.

The development process for software which is executed on smart cards is typically very cumbersome and requires special skills. This is because of the fact that resources are very limited and that therefore a lot of programming has to be done either in assembler or very low-level C language.

In order to mitigate this problem, the above-mentioned virtual machines have been introduced into smart cards. Java Card is by far the most prominent example. Another example is MULTOS. In the case of Java Card, applications called “applets” are developed in the Java programming language. These applets make use of a rich Java Card application programming interface (API) for essential functionality, such as communication, transactions, or cryptography. This significantly speeds up the development process and makes applets independent of the underlying hardware. This independence is achieved by executing so-called byte codes using a virtual machine on the smart card instead of executing native assembler code by the central processing unit (CPU) of the smart card.

However, many checks of the byte codes have to be performed in order to guarantee the security of the smart card platform and of other applets which exist in parallel on the same smart card. Some of these checks are rather resource intensive. Therefore, in state-of-the-art

Java Cards, these checks are separated into two parts: (1) off-card checks, which are performed using a tool on a personal computer (PC), and (2) on-card checks, which are performed using the virtual machine on a smart card.

In this context, the requirement for integrity protection of the applet between the off-card check and the actual deployment on the smart card presents a problem. Without the integrity protection the security of the smart card cannot be ensured, because the smart card has to trust the environment that it has properly performed all the off-card checks.

Integrity protection is typically provided by using asymmetric cryptography to create a signature on the applet after having passed the off-card checks. This signature is then verified by the card upon loading of the applet. This procedure provides the proper integrity protection. However, it also requires a key setup between the party who performs the off-card checks and the smart card wherein the applet will be deployed.

This key setup requires some kind of business relationship between the applet provider or service provider and the card issuer. The idea of an “applet store” where one can just pick any applet and deploy it on any technically compatible smart card is therefore infeasible.

Accordingly, there is a need for a more flexible deployment of applets on smart cards. More specifically, there is a need to mitigate the requirement that smart cards have to trust their environment with respect to having properly performed off-card checks.

### SUMMARY OF THE INVENTION

It is an object of the invention to facilitate a more flexible deployment of applets on smart cards. This object is achieved by a process for verifying a computer program on a smart card as defined in claim 1, and by a system for verifying a computer program on a smart card as defined in claim 8.

According to an aspect of the invention, a process for verifying a computer program on a smart card is conceived, the process comprising: identifying, within said computer program, one or more instruction sequences that have a single start point and one or more end points in the program flow; identifying, in each instruction sequence, one or more basic blocks that have a single start point and a single end point in the program flow; and verifying the instruction sequences by verifying each basic block identified in said instruction sequences.

According to an exemplary embodiment, each instruction sequence operates on a memory frame that is reserved for storing operands and results of instructions comprised in the respective instruction sequence.

According to a further exemplary embodiment, wherein verifying a basic block comprises verifying, for each instruction comprised in said basic block, that the memory frame comprises operands required by said instruction, that said operands have the correct type, and that said operands are accessible for said instruction.

According to a further exemplary embodiment, the memory frame corresponds to a memory area of a transient memory unit of the smart card.

According to a further exemplary embodiment, upon verifying a basic block, it is determined whether said basic block shall be normalized by comparing the state of the memory frame with a predefined state.

According to a further exemplary embodiment, if it is determined, upon verifying a basic block, that said basic block shall be normalized, a transform function is calculated while verifying said basic block, in order to transform the memory frame after said basic block has been verified.

According to a further exemplary embodiment, if it is determined, upon verifying the basic block, that said basic block shall be normalized, then all subsequent basic blocks in the program flow shall be normalized by applying the inverse transform function.

According to a further aspect of the invention, a system for verifying a computer program on a smart card is conceived, the system comprising: a part for identifying, within said computer program, one or more instruction sequences that have a single start point and one or more end points in the program flow; a part for identifying, in each instruction sequence, one or more basic blocks that have a single start point and a single end point in the program flow; and a part for verifying the instruction sequences by verifying each basic block identified in said instruction sequences.

### BRIEF DESCRIPTION OF THE DRAWINGS

The invention will be described in more detail with reference to the appended drawings, in which:

FIG. 1 illustrates a typical architecture of a smart card;

FIG. 2 illustrates a process for verifying a computer program on a smart card in accordance with an exemplary embodiment of the invention.

### DESCRIPTION OF EMBODIMENTS

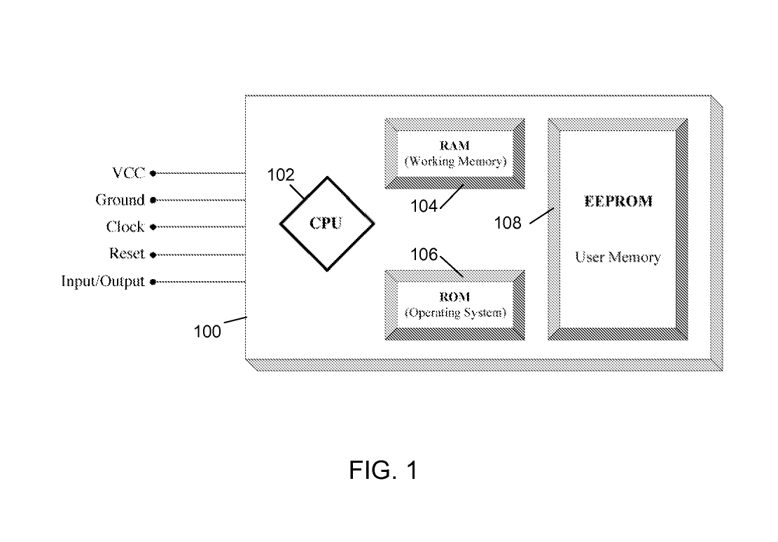

FIG. 1 illustrates a typical architecture of a smart card. The smart card 100 comprises a central processing unit 102, a random access memory 104, a read-only memory 106 and a non-volatile memory 108, in particular an electrically erasable programmable read-only memory. These components are interconnected (not shown) in order to execute the functions provided by the smart card 100. The random access memory 104 is an example of a transient or volatile memory and is typically used as a working memory of the central processing unit 102. The read-only memory 106 is typically used for storing the operating system of the smart card 100. The electrically erasable programmable read-only memory 108 is an example of a persistent or non-volatile memory and is typically used as a user memory, i.e. for storing applications (applets) which implement the aforementioned functions provided by the smart card 100. Instead of an electrically erasable programmable read-only memory a Flash memory may be used, which is another example of a non-volatile memory. As mentioned above, there is a need for a more flexible deployment of applets on smart cards.

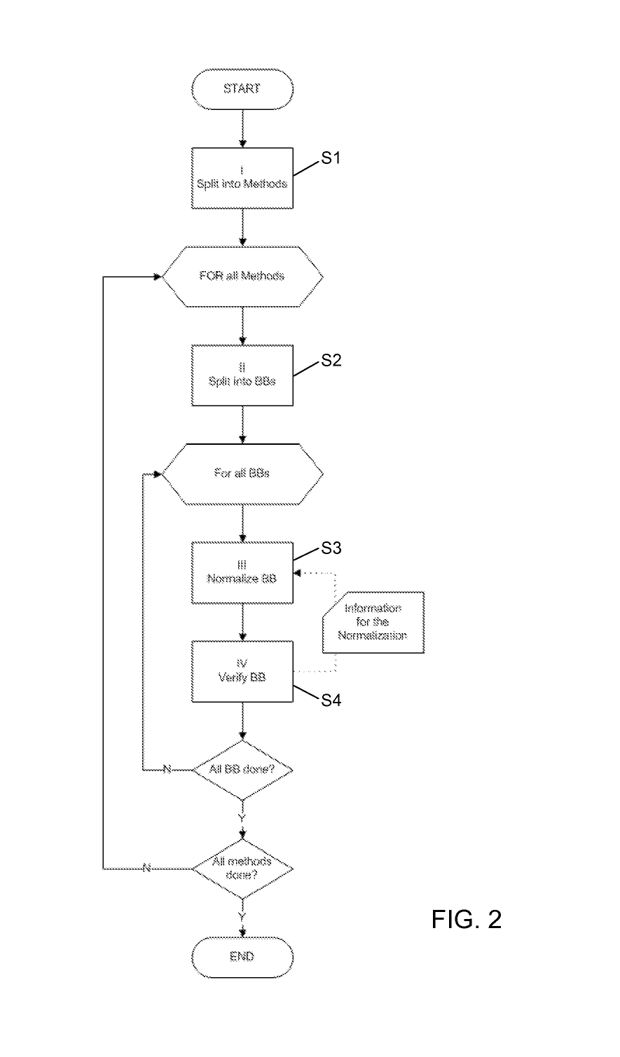

FIG. 2 illustrates a process for verifying a computer program on a smart card in accordance with an exemplary embodiment of the invention.

The verification process is embedded in the following sequence: first it begins with compiling the source code of the computer program to an intermediate language, for example Java byte codes. The compiled code is loaded into the system via the communication interface of the smart card. When the code has been loaded the verification starts. If the verification process succeeds, the code is installed on the smart card's system. Subsequently, the code may be executed.

The system comprises a central processing unit and at least two kinds of memory (transient and persistent) as well as a communication interface. The system is equipped with an interpreter for the aforementioned intermediate language. For example, the system may be equipped with a Java Virtual Machine capable of interpreting Java byte codes. The intermediate language consists of a specified set of rules, called instructions; these can be read and interpreted by the aforementioned interpreter. These instructions are strictly defined by the types of data they use.

A computer program loaded into the system is structured into sequences of instructions. These sequences of instructions are referred to as “methods” herein for the sake of brevity. A method consists of a defined sequence of instruction with exactly one start point and one or more end points in the program flow. Each method of a program can be seen as an independent object for the verification, because each method works on its own memory frame (MF), where it stores all operands for its instructions and their results.

According to the present disclosure, the methods of the loaded program are split into one or more so-called “basic blocks” (BBs). A BB is a subsequence of one method that has exactly one entry or start point, which is the first instruction of the BB, and exactly one end point, which is the last instruction of the BB. Each end point of a BB points to a start point of one or more following BBs. Therefore, all BBs of a method will build a so called flow graph (FG).

The type verification process is done on each of the BBs. In other words, each basic block in each sequence of instructions identified in the computer program is verified in order to verify the whole computer program. More specifically, verifying a basic block comprises verifying, for each instruction comprised in said basic block, that the memory frame comprises operands required by said instruction, that said operands have the correct type, and that said operands are accessible for said instruction.

The verification of the computer program is shown in FIG. 2. It starts with splitting S1 the computer program into methods, i.e. into instruction sequences with exactly one start point and one or more end points in the program flow. Subsequently, each of these methods is split S2 into BBs and the corresponding FG of the method. At this stage, each of the BBs is marked as not verified. Subsequently, two steps are performed for each BB. First, the BB is normalized S3 if this is necessary. “Normalizing” is defined as bringing the MF of the method in a predefined state at the beginning of the BB. Second, the BB has to be verified S4. During this verification all the required information for potential subsequent normalization is calculated. When all BBs of a method have been verified, the next method will be verified. The verification process has finished when all methods have been verified.

The goal of the verification is to ensure that each instruction has all the operands it needs in the defined MF. The verification is done on BBs; a precondition is that the MF is in a predefined state at the beginning of this BB. This is achieved by a normalization step.

The verification itself will be done by the interpretation of each instruction in respect of the used types of operands. This means that it will be checked for each instruction that all needed operands of the correct types are saved in the MF and that they are accessible for the instruction. This is done for each instruction of the BB and as long as the state of the MF after the last instruction of the BB is not modified. If the state of the MF after the last instruction is not equal to the predefined state, a transform function T will be calculated by the system. This function is needed by the normalization to transform the MF at the end of this BB and the beginning of each following BB. When the verification process has verified the last instruction of a BB, this BB is marked as verified.

The normalization applies the transform function T (as calculated during verification) to the BBs. When the verification of a BB detects that this BB needs to be normalized, it calculates the transform function T. This function maps the actual state of the MF to the predefined state of the MF. Its inverse maps the predefined state of the MF to the actual state of the MF. With this transform function T the normalization can compute the correct instruction to achieve a defined state for the MF. If the current BB is normalized, all its successors in the FG need to be normalized with the inverse function of T as well. This is done as follows: all successors S of the current BB are also transformed with the inverse function of T. Then for each of this successors S its predecessors are transformed with the function T, except the current BB, which is already done. Each BB that is visited by the normalization is marked as not verified and has to be re-verified. The complete verification process can be executed in the transient memory of the system.

Reiterating, the verification process or algorithm according to an exemplary embodiment of the invention may comprise the following parts: (1) identification of methods, (2) identification of basic blocks, (3) verification of each basic block, and (4) if necessary, normalization. The complete verification process may be executed on the smart card and will work with the complete set of byte codes as for example specified by the Java Card Platform.

The above-mentioned embodiments illustrate rather than limit the invention, and the skilled person will be able to design many alternative embodiments without departing from the scope of the appended claims. In the claims, any reference sign placed between parentheses shall not be construed as limiting the claim. The word “comprise(s)” or “comprising” does not exclude the presence of elements or steps other than those listed in a claim. The word “a” or “an” preceding an element does not exclude the presence of a plurality of such elements. The invention may be implemented by means of hardware comprising several distinct elements and/or by means of a suitably programmed processor. In a device claim enumerating several means, several of these means may be embodied by one and the same item of hardware. The mere fact that certain measures are recited in mutually different dependent claims does not indicate that a combination of these measures cannot be used to advantage.

### List of Reference Signs

100 smart card

102 central processing unit

104 random access memory

106 read-only memory

108 non-volatile memory

S1 step “split into methods”

S2 step “split into basic blocks”

S3 step “normalize basic block”

S4 step “verify basic block”

1. A process for verifying a computer program on a smart card, the process comprising:
identifying, within said computer program, one or more instruction sequences that have a single start point and one or more end points in the program flow;
identifying, in each instruction sequence, one or more basic blocks that have a single start point and a single end point in the program flow;
verifying the instruction sequences by verifying each basic block identified in said instruction sequences.

2. A process as claimed in claim 1,
wherein each instruction sequence operates on a memory frame that is reserved for storing operands and results of instructions comprised in the respective instruction sequence.

3. A process as claimed in claim 2,
wherein verifying a basic block comprises verifying, for each instruction comprised in said basic block, that the memory frame comprises operands required by said instruction, that said operands have the correct type, and that said operands are accessible for said instruction.

4. A process as claimed in claim 2,
wherein the memory frame corresponds to a memory area of a transient memory unit of the smart card.

5. A process as claimed in claim 2,
wherein, upon verifying a basic block, it is determined whether said basic block shall be normalized by comparing the state of the memory frame with a predefined state.

6. A process as claimed in claim 5,
wherein, if it is determined, upon verifying a basic block, that said basic block shall be normalized, a transform function is calculated while verifying said basic block, in order to transform the memory frame after said basic block has been verified.

7. A process as claimed in claim 6,
if it is determined, upon verifying the basic block, that said basic block shall be normalized, then all subsequent basic blocks in the program flow shall be normalized by applying the inverse of the transform function.

8. A system for verifying a computer program on a smart card, the system comprising:
a part for identifying, within said computer program, one or more instruction sequences that have a single start point and one or more end points in the program flow;
a part for identifying, in each instruction sequence, one or more basic blocks that have a single start point and a single end point in the program flow;
a part for verifying the instruction sequences by verifying each basic block identified in said instruction sequences.
